(19) United States
(12) Patent Application Publication
(10) Pub. No.: US 2005/0122338 A1
(43) Pub. Date: Jun. 9, 2005

(54) Apparatus and method for rendering graphics primitives using a multi-pass rendering approach

(76) Inventors: Michael Hong, Cupertino, CA (US); Jiangming Xu, San Jose, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/729,684

(22) Filed: Dec. 5, 2003

(51) Int. Cl. G09G 5/397; G06T 15/40; G06T 1/20; G09G 5/36; G06T 15/00

(52) U.S. Cl. 345/546; 345/422; 345/506; 345/553; 345/419; 345/545

(57) ABSTRACT

The present invention is generally directed to a multi-pass rendering system and method. In one embodiment, in first pass of a graphics primitive data through a graphics pipeline, a compressed z-buffer is generated for the primitive. A primitive mask is also generated, which indicates whether all pixels of the primitive are hidden from view. In a second pass, graphics data for a given primitive is passed through the pipeline, only if the primitive mask for that primitive indicates that some portion of the primitive is visible. Thereafter, a two-level z-test is performed on that primitive. In the two-level z-test, a first level comparison is made on groups of pixels at a time, using the compressed z-buffer created in the first pass.

### FIELD OF THE INVENTION

The present invention generally relates to graphics systems, and more particularly to an apparatus and method for rendering graphics primitives using a multi-pass rendering approach.

### BACKGROUND

As is known, the art and science of three-dimensional (“3-D”) computer graphics concerns the generation, or rendering, of two-dimensional (“2-D”) images of 3-D objects for display or presentation onto a display device or monitor, such as a Cathode Ray Tube (CRT) or a Liquid Crystal Display (LCD). The object may be a simple geometry primitive such as a point, a line segment, a triangle, or a polygon. More complex objects can be rendered onto a display device by representing the objects with a series of connected planar polygons, such as, for example, by representing the objects as a series of connected planar triangles. All geometry primitives may eventually be described in terms of one vertex or a set of vertices, for example, coordinate (x, y, z) that defines a point, for example, the endpoint of a line segment, or a corner of a polygon.

To generate a data set for display as a 2-D projection representative of a 3-D primitive onto a computer monitor or other display device, the vertices of the primitive are processed through a series of operations, or processing stages in a graphics-rendering pipeline. A generic pipeline is merely a series of cascading processing units, or stages, wherein the output from a prior stage serves as the input for a subsequent stage. In the context of a graphics processor, these stages include, for example, per-vertex operations, primitive assembly operations, pixel operations, texture assembly operations, rasterization operations, and fragment operations.

In a typical graphics display system, an image database (e.g., a command list) may store a description of the objects in the scene. The objects are described with a number of small polygons, which cover the surface of the object in the same manner that a number of small tiles can cover a wall or other surface. Each polygon is described as a list of vertex coordinates (X, Y, Z in “Model” coordinates) and some specification of material surface properties (i.e., color, texture, shininess, etc.), as well as possibly the normal vectors to the surface at each vertex. For three-dimensional objects with complex curved surfaces, the polygons in general must be triangles or quadralaterals, and the latter can always be decomposed into pairs of triangles.

A transformation engine transforms the object coordinates in response to the angle of viewing selected by a user from user input. In addition, the user may specify the field of view, the size of the image to be produced, and the back end of the viewing volume so as to include or eliminate background as desired.

Once this viewing area has been selected, clipping ligic eliminates the polygons (i.e., triangles) which are outside the viewing area and “clips” the polygons, which are partly inside and partly outside the viewing area. These clipped polygons will correspond to the portion of the polygon inside the viewing area with new edge(s) corresponding to the edge(s) of the viewing area. The polygon vertices are then transmitted to the next stage in coordinates corresponding to the viewing screen (in X, Y coordinates) with an associated depth for each vertex (the Z coordinate). In a typical system, the lighting model is next applied taking into account the light sources. The polygons with their color values are then transmitted to a rasterizer.

For each polygon, the rasterizer determines which pixel positions are covered by the polygon and attempts to write the associated color values and depth (Z value) into frame buffer. The rasterizer compares the depth values (Z) for the polygon being processed with the depth value of a pixel, which may already be written into the frame buffer. If the depth value of the new polygon pixel is smaller, indicating that it is in front of the polygon already written into the frame buffer, then its value will replace the value in the frame buffer because the new polygon will obscure the polygon previously processed and written into the frame buffer. This process is repeated until all of the polygons have been rasterized. At that point, a video controller displays the contents of a frame buffer on a display a scan line at a time in raster order. With this general background provided, reference is now made to FIG. 1, which shows a functional flow diagram of certain components within a graphics pipeline in a computer graphics system. It will be appreciated that components within graphics pipelines may vary from system, and may also be illustrated in a variety of ways. The components of FIG. 1 have been depicted in the manner shown to better illustrate certain features of the present invention, with reference to later-described drawings.

As is known, a host computer 10 (or a graphics API running on a host computer) may generate a command list 12, which comprises a series of graphics commands and data for rendering an “environment” on a graphics display. Components within the graphics pipeline may operate on the data and commands within the command list 12 to render a screen in a graphics display.

In this regard, a parser 14 may retrieve data from the command list 12 and “parse” through the data to interpret commands and pass data defining graphics primitives along (or into) the graphics pipeline. In this regard, graphics primitives may be defined by location data (e.g., x, y, z, and w coordinates) as well as lighting and texture information. All of this information, for each primitive, may be retrieved by the parser 14 from the command list 12, and passed to a vertex shader 16. As is known, the vertex shader 16 may perform various transformations on the graphics data received from the command list. In this regard, the data may be transformed from World coordinates into Model View coordinates, into Projection coordinates, and ultimately into Screen coordinates. The functional processing performed by the vertex shader 16 is known and need not be described further herein. Thereafter, the graphics data may be passed onto rasterizer 18, which operates as summarized above.

Thereafter, a z-test 20 is performed on each pixel within the primitive being operated upon. As is known, this z-test is performed by comparing a current z-value (i.e., a z-value for a given pixel of the current primitive) in comparison with a stored z-value for the corresponding pixel location. The stored z-value provides the depth value for a previously-rendered primitive for a given pixel location. If the current z-value indicates a depth that is closer to the viewer's eye than the stored z-value, then the current z-value will replace the stored z-value and the current graphic information (i.e., color) will replace the color information in the corresponding frame buffer pixel location (as determined by the pixel shader 22). If the current z-value is not closer to the current viewpoint than the stored z-value, then neither the frame buffer nor z-buffer contents need to be replaced, as a previously rendered pixel will be deemed to be in front of the current pixel.

Again, for pixels within primitives that are rendered and determined to be closer to the viewpoint than previously-stored pixels, information relating to the primitive is passed on to the pixel shader 22 which determines color information for each of the pixels within the primitive that are determined to be closer to the current viewpoint. Once color information is computed by the pixel shader 22, the information is stored within the frame buffer 24.

Although the foregoing has only briefly summarized the operation of the various processing components, persons skilled in the art recognize that the processing on graphics data is quite intense. In this regard, a significant amount of data is retrieved from the command list 12 and processed. In situations where there is a large amount of “overdraw,” much of the processing that is performed is ultimately unnecessary. In this regard, an overdraw is a situation where a pixel is rendered and stored in the frame buffer only to be overwritten by a subsequently-processed pixel of another primitive. Although programmers can choose to order primitives when rendering a graphic scene from, for example, front to back to at least minimize, if not eliminate, overdraw situations, frequently programmers do not do this, and the graphics information that is placed in the command list 12 is unordered. Accordingly, it is desired to provide an improved architecture and/or method for improving the efficiency of graphics processing within a graphics pipeline.

### SUMMARY OF THE INVENTION

Certain objects, advantages and novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the appended claims.

To achieve certain advantages and novel features, the present invention is generally directed to a multi-pass rendering system and method. In one embodiment, in first pass of a graphics primitive data through a graphics pipeline, a compressed z-buffer is generated for the primitive. A primitive mask is also generated, which indicates whether all pixels of the primitive are hidden from view. In a second pass, graphics data for a given primitive is passed through the pipeline, only if the primitive mask for that primitive indicates that some portion of the primitive is visible. Thereafter, a two-level z-test is performed on that primitive. In the two-level z-test, a first level comparison is made on groups of pixels at a time, using the compressed z-buffer created in the first pass.

### DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a diagram illustrating a functional flow diagram of a convention pipeline of a graphics system;

FIGS. 2A and 2B are diagrams similar to FIG. 1, illustrating a graphics functional and operational components of a pipeline in a first pass and a second pass, respectively, of a two-pass rendering process.

FIG. 3 is a block diagram illustrating a compression of a z-buffer.

FIG. 4 is a flowchart illustrating a top-level operation of a two-pass graphics rendering system.

FIG. 5 is a block diagram illustrating certain components of a two-pass graphics rendering system.

### DETAILED DESCRIPTION

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

It is noted that the drawings presented herein have been provided to illustrate certain features and aspects of embodiments of the invention. It will be appreciated from the description provided herein that a variety of alternative embodiments and implementations may be realized, consistent with the scope and spirit of the present invention.

As summarized above, embodiments of the present invention provide improved graphics systems and methods for improving the efficiency of graphics processing within a graphics pipeline. Broadly, the functionality of certain embodiments provide for a two-pass rendering system, whereby only a limited set of graphics information is passed through the pipeline on a first pass. During the first-pass processing, a compressed z-buffer is formed and primitive masks are computed for each primitive. In one embodiment, the reduced amount of graphics data that is passed into the graphics pipeline includes only location information, and lighting, texture, fog, and other types of information are not passed from the command list into the graphics pipeline. This significantly improves the bandwidth of the information being processed within the graphics pipeline on the first pass. As will be described in more detail below, the compressed z-buffer effectively provides condensed depth information for multiple pixels, such that a grouping of pixels (or a macro-pixel) may be trivially accepted (during the second pass) if all pixels of a current macro-pixel are deemed to be in front of previously-stored pixels or trivially rejected if all pixels of the current macro-pixel primitive are deemed to be behind previously-stored pixels.

A primitive mask is also created during the first pass. This primitive mask may be contained within a single bit or byte of information, and indicates whether any part of the primitive is visible. In one embodiment, such a primitive mask indicates that a primitive is not visible if it is determined to be a zero-pixel primitive (i.e., a primitive that, when rendered, consumes less area than one pixel of visibility). The primitive mask may also indicate that a pixel is not visible if the primitive is one that would be completely culled or clipped. Likewise, the primitive may be deemed to be not visible if it is determined to be a back-facing primitive. Consistent with the concepts and teachings of the invention, other situations may likewise be indicative of non-visible primitives, and may be factored into the processing for generating the primitive masks.

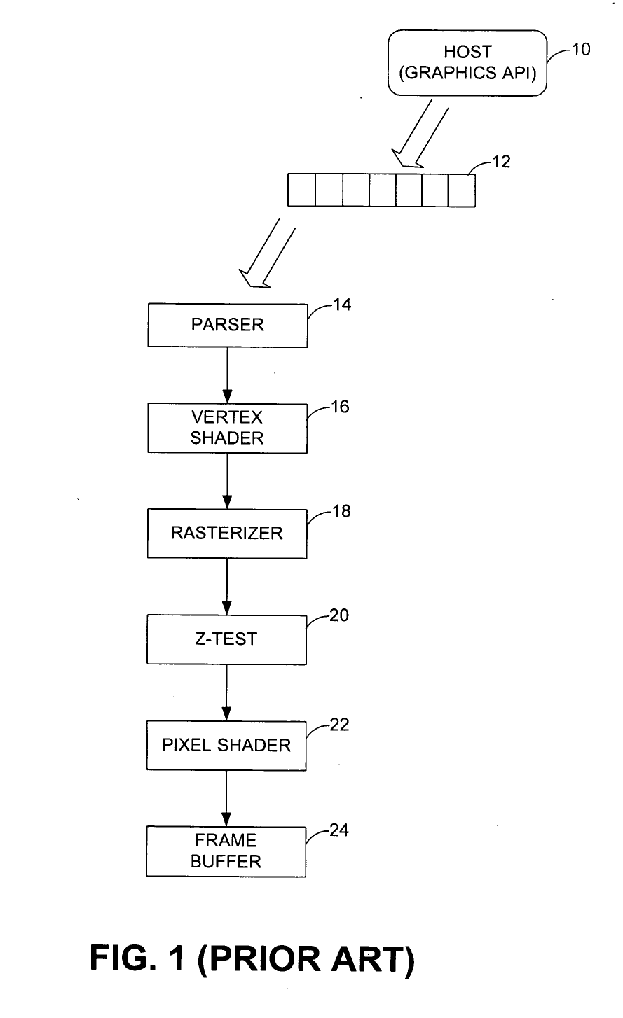

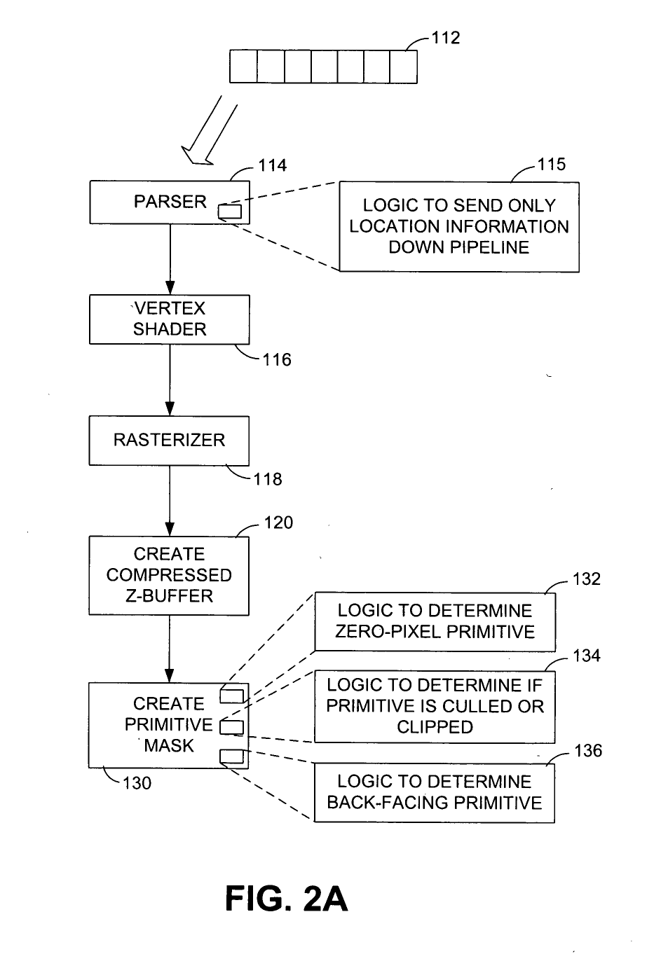

Reference is now made to FIGS. 2A and 2B, which illustrate certain components of a graphics system constructed in accordance with one embodiment of the present invention. The components illustrated in FIGS. 2A and 2B are similar, where possible, to the components illustrated in FIG. 1. Further, FIG. 2A provides an illustration of certain features and components that are operative in a first pass of the multi-pass rendering operation of an embodiment of the present invention, while FIG. 2B illustrates certain components and features that are operative on a second pass of the multi-pass rendering embodiment.

With regard to the novel graphics system and method, the operation of a number of the functional components is not significantly changed from prior art systems, and therefore need not be described herein. For example, operation of the vertex shader 116, rasterizer 118, pixel shader 140; frame buffer 144, etc., are known and substantially unchanged by the present invention, and therefore need not be described. Similarly, the parser 114 operates, in large part, similar to the parser 14 of FIG. 1. However, the parser 114 includes logic 115 to ensure that during the first pass of the rendering process only a limited set of the graphics data is sent down the graphics pipeline. In one embodiment, this limited set of graphics data is limited to location information, such as x, y, z, and w coordinates. Other graphics information such as lighting information, texture information, fog information, etc., are not passed into the remainder of the pipeline during the first pass of the rendering process. By limiting the amount of information that is passed into the graphics pipeline, significant bandwidth savings are realized by embodiments of the present invention.

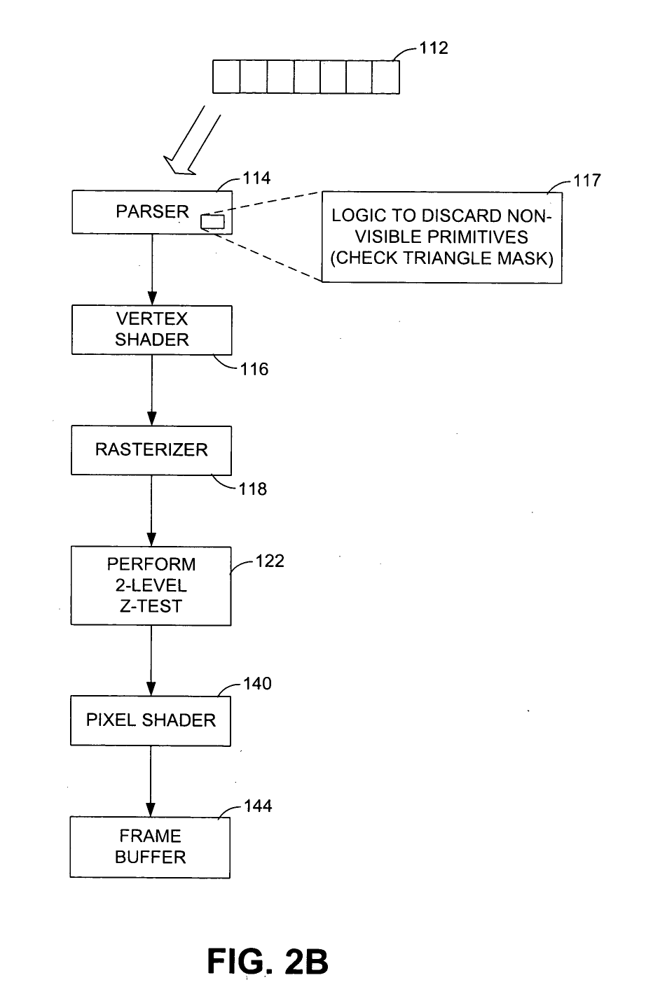

In keeping with the description of FIG. 2A, the vertex shader 116, in the first pass, operates only on the location information to perform the various transformations. The rasterizer 118 then rasterizes the current primitive. Thereafter, logic 120 operates to create a compressed z-buffer. In this regard, reference is made briefly to FIG. 3. As is known, a frame buffer 302 is a memory area for storing color information for each primitive on the display. Likewise, a z-buffer 304 is a memory area for storing depth information for each pixel of a display. The compressed z-buffer 306 of one embodiment compresses z-information for sixty-four pixels (an eight by eight pixel block, or macro-pixel) into a single record.

There are a variety of structures and embodiments the compressed z-buffer record may take. In one embodiment, the record for this compressed z-information includes a minimum z-value, a maximum z-value, and a 64-bit mask. The 64-bit mask allocates one bit per pixel of the z-buffer. The value of the bit indicates whether the pixel is inside or outside the rasterized primitive.

In another embodiment, the record for the compressed z-information may comprise two ranges of z values. That is, it may comprise two sets of max and min z values. To describe one motivation for storing two z ranges and an area mask instead of one simple z range, consider the following example. Assuming one z range (initialized to a maximum background value) and the rendering of two smooth surfaces represented by a mesh of triangles. If the first triangle fully covers the 8×8 tile and its current range is in front of the stored range (thus accepted) then the new z range is stored. However, if the first triangle only partially covers the 8×8 tile then the new compressed z record should contain the merged result of the current and stored range. Then, the range of the next adjacent triangle intersects (thus retest) with the stored range and so on. Rendering of the second surface that is behind the first surface again yields a retest. Since the primary objective of compressed z buffer is to avoid a useless retest, a better solution is sought.

A smooth surface represented by a mesh of triangles is considered a layer. Ideally, triangles of different layers should belong to different z ranges. By designating one range as “front layer” (z1range) and the other one as “back layer” (z2range), the probability of retests is significantly reduced without increasing the compressed z-buffer size significantly (a standard z buffer for an 8×8 tile can be interpreted as a range buffer with 64 perfectly thin ranges). Returning to the previous example, assuming both z ranges are initialized to the background and the area mask is set to zero (only z2range is valid). The first triangle partially covering the 8×8 tile is, as usual, accepted but creates a new front layer. The next adjacent triangle now yields the desired accept signal and is merged with the front layer and so on. Then, rendering of the second surface behind the first surface again yields the desired reject.

In this embodiment, since two z ranges are stored per 8×8 tile, any new triangle that is not totally rejected results in a merging of the current range and draw mask with the stored ranges and area mask. Even a simple overwrite (e.g., replacing the compressed z record with an accepted current range and fully covered draw mask) is considered a merge operation. It will be appreciated that smaller z ranges reduce the probability of retests, so the ZL1 merging unit incorporates the depth (range) and spatial (area) relationship to compute small ranges, when possible.

Although particular records defining a compressed z-buffer have been described above, it should be appreciated that, consistent with the scope and spirit of the present invention, a variety of record formats may be utilized.

In keeping with the description of FIG. 2A, logic 120 creates a compressed z-buffer for the primitive being currently processed. Thereafter, logic 130 creates a primitive mask (or triangle mask for triangle primitives) for the current primitive. The primitive mask may be a single value that indicates whether the entire primitive is hidden from view. As will be further described below, this information is used during the early phase of the second pass to skip or avoid the rendering of graphics information on primitives that are deemed to be hidden from view. In one embodiment, the logic 130 for creating the primitive mask may include logic 132 for determining whether the primitive is a zero-pixel primitive (i.e., a primitive that consumes less than one pixel of screen space). The logic 130 may also include logic 134 configured to determine whether the primitive is culled or clipped. Since culled and clipped primitives are not visible on the screen, they are hidden from view and the primitive mask may be set. The logic 130 may also include logic configured to determine whether the current primitive is a back-facing primitive, since back-facing primitives are similarly hidden from view. In any of these situations, the primitive (or triangle) mask for the current primitive may be set. Other situations may also lead to the setting of the primitive mask, consistent with the concepts and teachings of the present invention.

Reference is now made to FIG. 2B, which is a functional flow diagram illustrating certain features and functions of the graphics pipeline in a second pass of a primitive through the graphics pipeline. In the second pass, the parser 114 again retrieves graphics commands and primitive data from the command list 112. The parser 114 includes logic 117 that evaluates the triangle mask (created during the first pass) for the current primitive. If the primitive mask indicates that the primitive is hidden from view, then the parser 114 may discard the primitive data, as no further processing within the graphics pipeline will need to be performed on that primitive, and proceed to retrieve the information from the command list 112 for the next primitive. This achieves significant performance enhancements by eliminating substantial processing and computational operations by the various pipeline components, which operations otherwise have no impact on the visible image that is displayed.

If, however, the parser 114 determines from the primitive mask that the current primitive does have visible pixels, then the complete rendering information for that primitive is passed from the parser 114 to the vertex shader. The vertex shader 116 and rasterizer 118 perform conventional vertex shading and rasterization operations on this current primitive. Thereafter, logic 122 performs a two-level z-test. In this regard, a first level of the z-test is performed using the compressed z-buffer that was constructed during the first pass of operation. If it is determined in the first level of the z-test that all pixels of a current macro-pixel are behind the pixels of a corresponding macro-pixel of a previously-stored primitive(s), then no further processing need be performed on any of the corresponding pixels of the given macro-pixel (that is, the information for the corresponding pixels need not be passed to the pixel shader 140). Likewise, if it is determined that all pixels of a current macro-pixel lie in front of all previously-stored pixels for that macro-pixel, then all relevant graphics information for the corresponding pixels may be passed to the pixel shader 140. It should be appreciated that either of these scenarios eliminates the need to perform a pixel-by-pixel comparison for the z-buffer, thereby improving the bandwidth of the z-test.

If, however, macro-pixels of the compressed z-buffer cannot be either trivially accepted (i.e., all pixels lie in front of previously-stored pixels) or trivially rejected (i.e., all pixels lie behind previously-stored pixels), then a second level z-test is performed. The second level z-test is a conventionally z-test performed on each pixel of the z-buffer 304 (see FIG. 3).

Once the z-test 122 is performed, pixel information is passed to the pixel shader 140 for conventional processing. Appropriate resulting pixel information is then saved in the frame buffer 144. It should be appreciated that the multi-pass rendering system that has been described above realizes significant performance gains over prior-art systems.

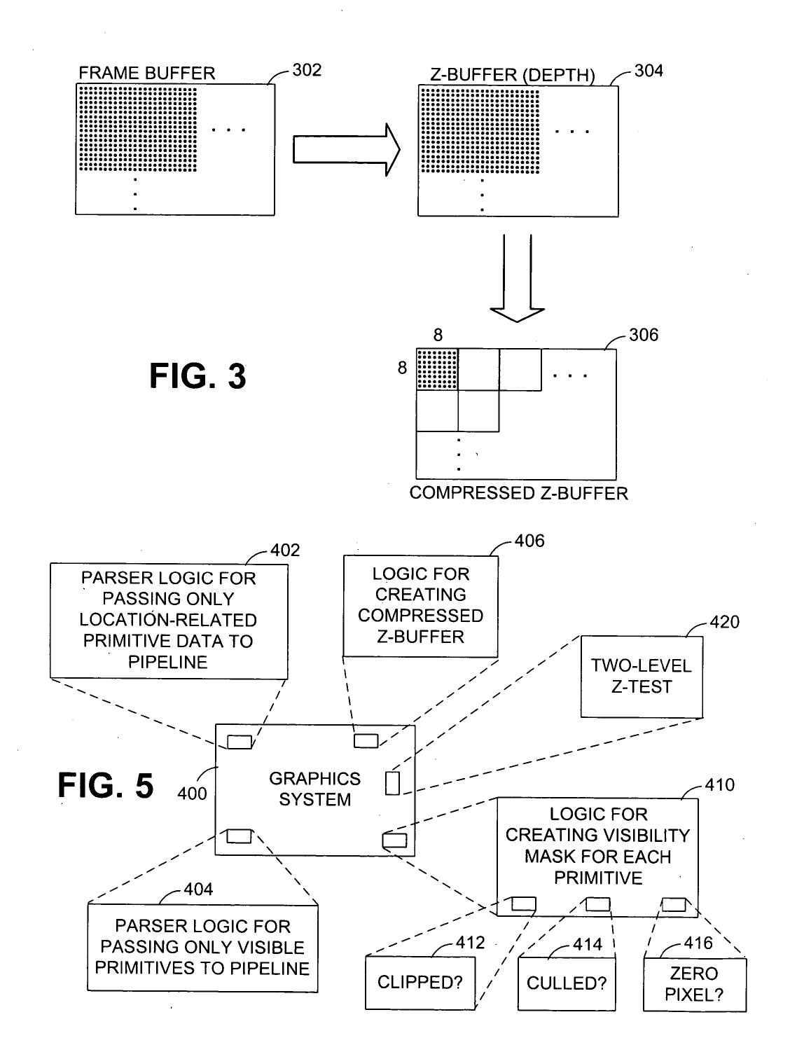

Reference is now made to FIG. 4, which is a flowchart illustrating a multi-pass rendering system constructed in accordance with one embodiment of the present invention. In accordance with this embodiment, primitive information is retrieved (202) from, for example, a command list. A determination 204 is then made to determine whether the graphics information is being processed in a first pass of the rendering system or a subsequent pass. If it is determined that the current operations are being performed in a first pass, then only location information for a current primitive is passed to the graphics pipeline for processing (206). During the processing of this location information, a first pass of the rendering system generates a compressed z-buffer (208). Also, for each primitive, the embodiment generates a primitive mask (210).

If it is determined (204) that the current processing is not a first pass of the rendering, then a determination (212) is made to determine whether the current primitive is visible or hidden from view. In a preferred embodiment, this determination is made by evaluating the primitive mask that was set (210). If, it is determined that no pixel of the current primitive is visible, then no further processing need be performed on this graphics primitive, and the method may return to step 202 to obtain primitive information for the next primitive. If, however, step 212 determines that one or more pixels of the current primitive are visible, then all relevant primitive information is passed (214) to the pipeline for further processing. Among other processing (e.g., vertex shading, rasterization, etc.), a z-test is performed using the compressed z-buffer (216). In this regard, compressed z-information generated (208) in the first pass is compared against stored compressed z-information for previously-processed pixel groups. If it is determined that all pixels of the current macro-pixel are hidden (218), then the method may return to 202 to obtain primitive information for the next primitive. If, however, it is determined (218) that all pixels of the current primitive are not hidden, then the method determines (220) whether all pixels of the current macro-pixel are visible. If so, the macro-pixels may be passed to the pixel shader. If, however, it is determine (220) that not all pixels are visible, then a conventional z-test is performed (222) on each pixel of the macro-pixel. Thereafter, pixel information is passed to the pixel shader (224) for convention pixel shading processing.

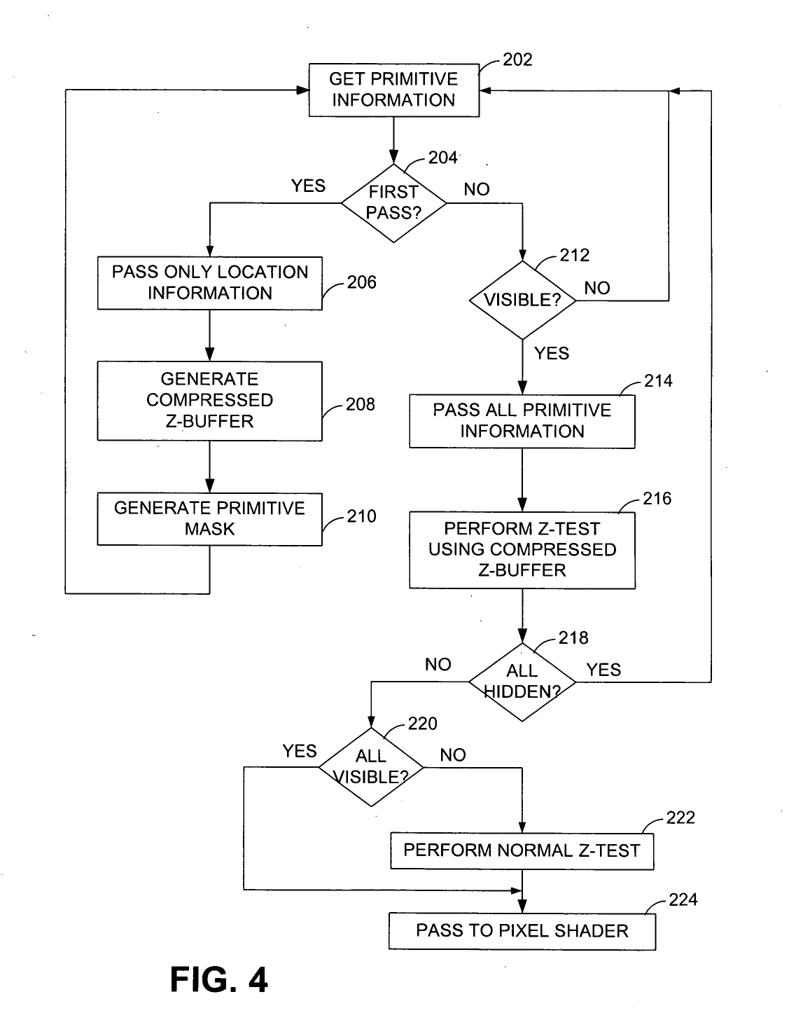

Reference is now made to FIG. 5, which illustrates certain components of a graphics system 400 constructed in accordance with an embodiment of the invention. In the embodiment of FIG. 5, the graphics system 400 includes parser logic 402 configured to pass to the remainder of the pipeline only location-related primitive data. The system 400 likewise includes parser logic 404 configured to pass only visible primitives to the pipeline for further processing. As previously described, logic 402 is operative during a first pass of primitive processing, while logic 404 is operative during a second pass of the rendering. The system 400 also includes logic 406 for creating a compressed z-buffer. The nature and content of this buffer have been described previously. The system 400 further includes logic 410 for creating a visibility mask for each primitive. In one embodiment, this logic 410 includes logic 412 for determining whether the current primitive is clipped, logic 414 for determining whether the current primitive is culled, and logic 416 for determining whether the current primitive is a zero-pixel primitive. In any of these scenarios, the primitive will not be visible to a viewer, and logic 410 sets the visibility mask accordingly. The system 400 further includes logic 420 for performing a two-level z-test, during a second pass of the processing. A first level of the z-test operates on the compressed z-information created by logic 406, comparing z-information on a macro-cell-by-macro-cell basis.

The foregoing description is not intended to be exhaustive or to limit the invention to the precise forms disclosed. Obvious modifications or variations are possible in light of the above teachings. Further, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

1. A multi-pass method of rendering a plurality of graphic primitives comprising:
in a first pass:
passing only a limited set of graphic data for each primitive through a graphic pipeline;
processing the limited set of data to build a compressed z-buffer, the compressed z-buffer comprising a plurality of z-records, each z-record embodying z information for a plurality of pixels;
setting a visibility indicator, for each primitive, if any pixel of the primitive is determined to be visible;
in a second pass:
for each primitive, determining whether the associated visibility indicator for that primitive is set;
discarding, without passing through the graphic pipeline, the primitives for which the associated visibility indicator is not set;
passing a full set of graphic data for each primitive determined to have the associated visibility indictor set; and
performing a two-level z-test on graphic data, wherein a first level of the z-test compares the graphic data of a current primitive with corresponding information in the compressed z-buffer, and wherein a second level of the z-test is performed on a per-pixel basis in a conventional z-test matter, wherein the second level z-test is performed only on pixels within a record of the compressed z-information in which the first level z-test determines that some but not all pixels of the macropixel are visible.

2. The method of claim 1, wherein passing only a limited set of graphic data more specifically comprises passing only location-related data through the pipeline.

3. The method of claim 2, wherein location-related data comprises X, Y, Z, and W values.

4. The method of claim 1, wherein each compressed z-record comprises a minimum z value for the plurality of pixels, a maximum z value for the plurality of pixels, and a coverage mask, the coverage mask indicating which of the plurality of pixels are visible for the current primitive.

5. The method of claim 1, wherein each compressed z-record comprises two minimum z values for the plurality of pixels, two maximum z values for the plurality of pixels, and a coverage mask, the coverage mask indicating which of the plurality of pixels are visible for the current primitive.

6. The method of claim 1, wherein setting the visibility indicator more specifically comprises setting a bit in a frame buffer memory.

7. The method of claim 1, wherein the discarding is performed by a parser.

8. A method of rendering a plurality of graphic primitives comprising:
processing, within a graphic pipeline, only a limited set of graphic data for each primitive;
determining, for each primitive, whether the primitive has at least one visible pixel;
processing, within the graphic pipeline, a full set of graphic data for only those primitives determined to have at least one visible pixel.

9. The method of claim 8, further comprising setting a visibility indicator for each pixel determined to have at least one visible pixel.

10. The method of claim 9, wherein setting the visibility indicator more specifically comprises setting a bit in a frame buffer memory.

11. The method of claim 8, wherein the processing only a limited set of graphic data more specifically comprises processing only location-related data.

12. The method of claim 8, wherein the determining whether the primitive has at least one visible pixel ensures that the primitive does not fail a compressed z-buffer test, ensures that all pixels of the primitive are not culled, ensures that the primitive does not render to zero pixels, and ensures that all pixels of the primitive are not clipped.

13. A method of rendering a plurality of graphic primitives comprising:
processing in a first pass, within a graphic pipeline, only a limited set of graphic data for each primitive;
processing the limited set of data to build a compressed z-buffer, the compressed z-buffer comprising a plurality of z-records, each z-record embodying z information for a plurality of pixels;
in a second pass, within the graphic pipeline, performing a two-level z-test on graphic data, wherein a first level of the z-test compares the graphic data of a current primitive with corresponding information in the compressed z-buffer, and wherein a second level of the z-test is performed on a per-pixel basis in a conventional z-test matter, wherein the second level z-test is performed only on pixels within a record of the compressed z-information in which the first level z-test determines that some but not all pixels of a macropixel are visible.

14. A graphics processor comprising:
first-pass logic configured to deliver to a graphic pipeline, in a first pass, only a limited set of graphic data for each primitive;
logic configured to process the limited set of graphic data for each primitive to create a compressed z-buffer;
logic configured to determine, for each primitive, whether the primitive has at least one visible pixel;
second-pass logic configured to deliver to the graphic pipeline, in a second pass, a full set of graphic data for only those primitives determined to have at least one visible pixel, the second-pass logic further configured to inhibit the delivery of graphic data to the graphic pipeline for primitives not determined to have at least one visible pixel.

15. The graphics processor of claim 14, wherein the first-pass logic and second-pass logic are contained within a parser.

16. The graphics processor of claim 14, wherein the logic configured to determine whether the primitive has at least one visible pixel ensures that the primitive does not fail a compressed z-buffer test, ensures that all pixels of the primitive are not culled, ensures that the primitive does not render to zero pixels, and ensures that all pixels of the primitive are not clipped.

17. The graphics processor of claim 14, further including logic for setting a visibility indicator for each primitive determined to have at least one visible pixel.

18. The graphics processor of claim 17, wherein the visibility indicator includes a single bit in a frame-buffer memory.

19. The graphics processor of claim 17, further including logic configured to associate each primitive processed in the first pass of the data with a distinct visibility indicator.

20. The graphics processor of claim 19, further including logic configured to evaluate, for each primitive presented for processing in the second pass, a status of the visibility indicator associated with the given primitive.

21. A graphics processor comprising:
logic configured to limit the processing of graphic data for each of a plurality of primitives, in a first pass within a graphic pipeline, wherein the limited processing determines whether the primitive has at least one visible pixel;
logic configured to render, in a second pass within the graphic pipeline, each primitive determined in the first pass to have at least one visible pixel.

22. The graphics processor of claim 21, wherein the logic configured to limit the processing ensures that the primitive does not fail a compressed z-buffer test, ensures that all pixels of the primitive are not culled, ensures that the primitive does not render to zero pixels, and ensures that all pixels of the primitive are not clipped.

23. The graphics processor of claim 21, wherein the logic configured to limit the processing of graphic data is within a parser.

24. The graphics processor of claim 21, further including logic configured to build a compressed z-buffer of data from processing of the graphic data in the first pass.

25. The graphics processor of claim 21, further including logic for setting a visibility indicator for each primitive processed in the first pass.

26. The graphics processor of claim 21, further including logic configured to evaluate the visibility indicator for each primitive prior to submitting the primitive to the logic configured to render in the second pass.
